(19) United States
(12) Patent Application Publication
(10) Pub. No.: US 2014/0000886 A1
(43) Pub. Date: Jan. 2, 2014

(54) PETROLEUM RECOVERY PROCESS AND SYSTEM

(71) Applicant: Shell Oil Company, Houston, TX (US)

(72) Inventors: Stanley Nemec MILAM, Houston, TX (US); John Justin FREEMAN, Houston, TX (US); Erik Willem TEGELAAR, Rijswijk (NL)

(21) Appl. No.: 13/926,838

(22) Filed: Jun. 25, 2013

Related U.S. Application Data
(60) Provisional application No. 61/664,895, filed on Jun. 27, 2012.

(51) Int. Cl. E21B 43/16; E21B 43/26; C09K 8/58; E21B 43/24

(52) U.S. Cl. CPC E21B 43/16; E21B 43/24; E21B 43/26; C09K 8/58
USPC 166/272.3; 166/305.1; 166/268; 166/308.1; 166/242.1; 166/52; 166/57; 166/177.5; 507/257

(57) ABSTRACT

A system and process are provided for recovering petroleum from a formation. An oil recovery formulation comprising at least 75 mol % dimethyl sulfide that is first contact miscible with a liquid petroleum composition is introduced into a subterranean petroleum bearing formation comprising heavy oil, extra heavy oil, or bitumen, and petroleum is produced from the formation.

The present application claims the benefit of U.S. Patent Application No. 61/664,895, filed Jun. 27, 2012, the entire disclosure of which is hereby incorporated by reference.

### FIELD OF THE INVENTION

The present invention is directed to a method of recovering petroleum from a subterranean formation, in particular, the present invention is directed to a method of enhanced oil recovery from a subterranean formation.

### BACKGROUND OF THE INVENTION

A large quantity of oil worldwide is located in heavy oil and bituminous petroleum-containing formations. Not including hydrocarbons in oil shale, it has been estimated that there are 1.3 to 1.5 trillion cubic meters (8-9 trillion barrels) of heavy oil and bitumen in-place worldwide. A large portion of these petroleum resources are contained in oil sands. Oil sands formations may occur from the surface of the earth to a depth of more than 2000 meters. Petroleum may be recovered from oil sands by surface mining oil sands formations to a depth of about 75 meters and stripping the petroleum from the oil sands. Petroleum in oil sands formations having a depth of 75 meters or greater may be recovered by in-situ extraction wherein wells are drilled into the formation to extract the petroleum therefrom.

In-situ extraction of petroleum from oil sands formations is typically impeded by the viscosity of the heavy oil or bitumen in the oil sands. Generally, the viscosity of petroleum in an oil sands formation is sufficiently great that the petroleum does not easily flow to a well for production. Thermal methods have been provided for reducing the viscosity of the petroleum in an oil sands formation by heating the petroleum in the formation, thereby enhancing the flow of the petroleum in the formation and enabling production of the petroleum from the formation via a well. Steam assisted gravity drainage (SAGD) and cyclic steam stimulation (CSS) are thermal methods utilized for reducing the viscosity of petroleum in an oil sands formation by heating the formation with steam that is injected into the formation.

Non-thermal methods of reducing the viscosity of petroleum in an oil sands formation have also been utilized to produce heavy oils from oil sands formations. VAPEX is a non-thermal oil production method in which a hydrocarbon solvent vapor (e.g. CH₄ to C₄H₁₀) is injected into an oil sands formation to reduce the viscosity of the petroleum, expanding and diluting the petroleum upon contact thereby enabling production of the diluted oil. The VAPEX process is most effective when utilized in formations containing petroleum having an API Gravity of greater than 20°. U.S. Pat. No. 3,838,738 provides a method of injecting carbon disulfide or toluene vapor as a solvent into an oil sands formation together with steam, where the solvent vapor mixes with bitumen in the oil sands formation and mobilizes the bitumen as it condenses.

Despite the existence of in-situ extraction methods to extract petroleum from deeper oil sands formations, oil sands mining produces a disproportionate quantity of petroleum from oil sands formations relative to the total quantity of petroleum in oil sands formations. Almost 80% of all petroleum in oil sands formations is located in formations too deep for oil sands mining. However, only 41% of petroleum produced from oil sands formations is produced from such formations. The remaining 59% of such petroleum is produced by oil sands mining from formations accessible by mining—which comprise only 20% of the petroleum available in oil sands formations. Improvements to existing in-situ oil sands extraction methods are desirable. For example, in-situ extraction methods that increase petroleum recovery from a formation while minimizing formation souring, minimizing loss of oil recovery agent due to its solubility in formation water, reducing the toxicity of an extraction solvent, eliminating formation clean-up required as a result of the toxicity of the oil recovery agent, and that are economically advantaged relative to current in-situ extraction methods are desired.

### SUMMARY OF THE INVENTION

In one aspect, the present invention is directed to method for recovering petroleum, comprising:

providing an oil recovery formulation that comprises at least 75 mol % dimethyl sulfide and that is first contact miscible with liquid phase petroleum;

introducing the oil recovery formulation into a subterranean petroleum-bearing formation comprising petroleum having a dynamic viscosity of at least 1000 mPa s (1000 cP) at 25° C. and an API gravity of at most 20°;

contacting the oil recovery formulation with petroleum in the subterranean formation; and

producing petroleum from the formation after introduction of the oil recovery formulation into the formation and contact of the oil recovery formulation with the petroleum.

In another aspect, the present invention is directed to a system comprising:

an oil recovery formulation comprised of at least 75 mol % dimethyl sulfide that is first contact miscible with liquid phase petroleum;

a subterranean petroleum-bearing formation comprising petroleum having a viscosity of at least 1000 mPa s (1000 cP) at 25° C. and an API gravity of at most 20°;

a mechanism for introducing the oil recovery formulation into the subterranean petroleum-bearing formation; and

a mechanism for producing petroleum from the subterranean petroleum-bearing formation subsequent to the introduction of the oil recovery formulation into the formation.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an illustration of a petroleum production system in accordance with the present invention.

FIG. 2 is an illustration of a petroleum production system in accordance with the present invention.

FIG. 3 is an illustration of a petroleum production system in accordance with the present invention.

FIG. 4 is a diagram of a well pattern for production of petroleum in accordance with a system and process of the present invention.

FIG. 5 is a diagram of a well pattern for production of petroleum in accordance with a system and process of the present invention.

FIG. 6 is a graph showing petroleum recovery from oil sands at 30° C. using various solvents.

FIG. 7 is a graph showing petroleum recovery from oil sands at 10° C. using various solvents.

FIG. 8 is a graph showing the viscosity reducing effect of increasing concentrations of dimethyl sulfide on a West African Waxy crude oil.

FIG. 9 is a graph showing the viscosity reducing effect of increasing concentrations of dimethyl sulfide on a Middle Eastern Asphaltic crude oil.

FIG. 10 is a graph showing the viscosity reducing effect of increasing concentrations of dimethyl sulfide on a Canadian Asaphaltic crude oil.

### DETAILED DESCRIPTION OF THE INVENTION

The present invention is directed to a method and a system for enhanced oil recovery from a subterranean petroleum-bearing formation comprised of heavy oil, extra-heavy oil, or bitumen utilizing an oil recovery formulation comprising at least 75 mol % dimethyl sulfide. The oil recovery formulation is first contact miscible with liquid phase petroleum, and, in particular, is first contact miscible with petroleum in the subterranean petroleum-bearing formation. The oil recovery formulation may have a very low viscosity so that upon introduction of the oil recovery formulation into the formation the miscible oil recovery formulation may completely mix with the petroleum it contacts to produce a mixture having a significantly reduced viscosity relative to the petroleum initially in place in the formation. The reduced viscosity mixture may be mobilized for movement through the subterranean formation, where the mobilized mixture may be produced from the formation, thereby recovering petroleum from the formation.

Certain terms used herein are defined as follows:

“API gravity” as used herein refers to API gravity at 15.5° C. (60° F.) as determined by ASTM Method D6822.

“Asphaltenes”, as used herein, are defined as hydrocarbons that are insoluble in n-heptane and soluble in toluene at standard temperature and pressure.
“Fluidly operatively coupled or fluidly operatively connected”, as used herein, defines a connection between two or more elements in which the elements are directly or indirectly connected to allow direct or indirect fluid flow between the elements. The term “fluid flow”, as used herein, refers to the flow of a gas or a liquid.
“Miscible”, as used herein, is defined as the capacity of two or more substances, compositions, or liquids to be mixed in any ratio without separation into two or more phases.
“Petroleum”, as used herein, is defined as a naturally occurring mixture of hydrocarbons, generally in a liquid state, which may also include compounds of sulfur, nitrogen, oxygen, and metals.
“Residue”, as used herein, refers to petroleum components that have a boiling range distribution above 538° C. (1000° F.) as determined by ASTM Method D7169.

The oil recovery formulation provided for use in the method or system of the present invention is comprised of at least 75 mol % dimethyl sulfide. The oil recovery formulation may be comprised of at least 80 mol %, or at least 85 mol %, or at least 90 mol %, or at least 95 mol %, or at least 97 mol %, or at least 99 mol % dimethyl sulfide. The oil recovery formulation may be comprised of at least 75 vol. %, or at least 80 vol. %, or at least 85 vol %, or at least 90 vol %, or at least 95 vol. %, or at least 97 vol. %, or at least 99 vol. % dimethyl sulfide. The oil recovery formulation may be comprised of at least 75 wt. %, or at least 80 wt. %, or at least 85 wt. %, or at least 90 wt. %, or at least 95 wt. %, or at least 97 wt. %, or at least 99 wt. % dimethyl sulfide. The oil recovery formulation may consist essentially of dimethyl sulfide, or may consist of dimethyl sulfide.

The oil recovery formulation provided for use in the method or system of the present invention may be comprised of one or more co-solvents that form a mixture with the dimethyl sulfide in the oil recovery formulation. The one or more co-solvents are preferably miscible with dimethyl sulfide. The one or more co-solvents may be selected from the group consisting of o-xylene, toluene, carbon disulfide, dichloromethane, trichloromethane, C₃ to C₈ aliphatic and aromatic hydrocarbons, natural gas condensates, hydrogen sulfide, diesel, kerosene, dimethyl ether, and mixtures thereof.

The oil recovery formulation provided for use in the method or system of the present invention is first contact miscible with liquid petroleum compositions, preferably any liquid petroleum composition. In liquid phase or in gas phase the oil recovery formulation may be first contact miscible with substantially all crude oils including heavy crude oils, extra-heavy crude oils, and bitumen, and is first contact miscible in liquid phase or in gas phase with the petroleum in the petroleum-bearing formation. The oil recovery formulation may be first contact miscible with a hydrocarbon composition, for example a liquid phase petroleum, that comprises at least 25 wt. %, or at least 30 wt. %, or at least 35 wt. %, or at least 40 wt. % hydrocarbons that have a boiling point of at least 538° C. (1000° F.) as determined by ASTM Method D7169. The oil recovery formulation may be first contact miscible with liquid phase residue and liquid phase asphaltenes in a hydrocarbonaceous composition, for example a liquid phase petroleum. The oil recovery formulation may also be first contact miscible with C₃ to C₈ aliphatic and aromatic hydrocarbons containing less than 5 wt. % oxygen, less than 10 wt. % sulfur, and less than 5 wt. % nitrogen.

The oil recovery formulation may be first contact miscible with petroleum having a moderately high or a high viscosity. The oil recovery formulation may be first contact miscible with petroleum having a dynamic viscosity of at least 1000 mPa s (1000 cP), or at least 5000 mPa s (5000 cP), or at least 10000 mPa s (10000 cP), or at least 50000 mPa s (50000 cP), or at least 100000 mPa s (100000 cP), or at least 500000 mPa s (500000 cP) at 25° C. The oil recovery formulation may be first contact miscible with petroleum having a dynamic viscosity of from 1000 mPa s (1000 cP) to 5000000 mPa s (5000000 cP), or from 5000 mPa s (5000 cP) to 1000000 mPa s (1000000 cP), or from 10000 mPa s (10000 cP) to 500000 mPa s (500000 cP), or from 50000 mPa s (50000 cP) to 100000 mPa s (100000 cP) at 25° C.

The oil recovery formulation provided for use in the method or system of the present invention preferably has a low viscosity. The oil recovery formulation may be a fluid having a dynamic viscosity of at most 0.35 mPa s (0.35 cP), or at most 0.3 mPa s (0.3 cP), or at most 0.285 mPa s (0.285 cP) at a temperature of 25° C.

The oil recovery formulation provided for use in the method or system of the present invention preferably has a relatively low density. The oil recovery formulation may have a density of at most 0.9 g/cm³, or at most 0.85 g/cm³.

The oil recovery formulation provided for use in the method or system of the present invention may have a relatively high cohesive energy density. The oil recovery formulation provided for use in the method or system of the present invention may have a cohesive energy density of from 300 Pa to 410 Pa or from 320 Pa to 400 Pa.

The oil recovery formulation provided for use in the method or system of the present invention preferably is relatively non-toxic or is non-toxic. The oil recovery formulation may have an aquatic toxicity of LC₅₀ (rainbow trout) greater than 200 mg/l at 96 hours. The oil recovery formulation may have an acute oral toxicity of LD₅₀ (mouse and rat) of from 535 mg/kg to 3700 mg/kg, an acute dermal toxicity of LD₅₀ (rabbit) of greater 5000 mg/kg, and an acute inhalation toxicity of LC₅₀ (rat) of 40250 ppm at 4 hours.

In the method of the present invention the oil recovery formulation is introduced into a subterranean petroleum-bearing formation, and the system of the present invention includes a subterranean petroleum-bearing formation. The subterranean petroleum-bearing formation comprises petroleum and may comprise unconsolidated sand, rock, minerals, and water. The subterranean petroleum-bearing formation is located beneath an overburden that may extend from the earth's surface to the petroleum-bearing formation. The subterranean petroleum-bearing formation may be located at a depth of at least 75 meters, or at least 100 meters, or at least 500 meters, or at least 1000 meters, or at least 1500 meters below the earth's surface. The subterranean petroleum-bearing formation may have a permeability of from 0.00001 to 15 Darcy, or from 0.001 to 10 Darcy, or from 0.01 to 5 Darcy, or from 0.1 to 1 Darcy. The subterranean formation may be a subsea formation.

The subterranean petroleum-bearing formation comprises petroleum that may be separated and produced from the formation after contact and mixing with the oil recovery formulation. The petroleum of the petroleum-bearing formation is first contact miscible with the oil recovery formulation under formation pressure and temperature conditions and at standard temperature and pressure conditions. The petroleum of the petroleum-bearing formation is heavy oil, extra heavy oil, or bitumen. Heavy oil has an API Gravity of at most 20°. Extra heavy oil and bitumen each have an API gravity of at most 10°.

The petroleum contained in the petroleum-bearing formation has a dynamic viscosity under formation temperature conditions (specifically, at temperatures within the temperature range of the formation) of at least 1000 mPa s (1000 cP). The petroleum contained in the petroleum-bearing formation may have a dynamic viscosity under formation temperature conditions of at least 5000 mPa s (5000 cP), or at least 10000 mPa s (10000 cP), or at least 20000 mPa s (20000 cP) or at least 50000 mPa s (50000 cP), or at least 100000 mPa s (100000 cP). The petroleum contained in the petroleum-bearing formation may have a viscosity of from 1000 to 10000000 mPa s (1000-10000000 cP), or from 5000 to 1000000 mPa s (5000-1000000 cP), or from 10000 to 500000 mPa s (10000-500000 cP) under formation temperature conditions. The petroleum contained in the petroleum-bearing formation has a dynamic viscosity of at least 1000 mPa s (1000 cP) at 25° C., and may have a dynamic viscosity at 25° C. of at least 5000 mPa s (5000 cP), or at least 10000 mPa s (10000 cP), or at least 20000 mPa s (20000 cP), or at least 50000 mPa s (50000 cP), or at least 100000 mPa s (100000 cP). In an embodiment of the method and the system of the present invention, the viscosity of the petroleum contained in the petroleum-bearing formation is at least partially, or is substantially, responsible for immobilizing at least a portion of the petroleum in the formation.

The petroleum contained in the petroleum-bearing formation may contain a substantial quantity of high molecular weight hydrocarbons. The petroleum contained in the petroleum-bearing formation may contain at least 25 wt. %, or at least 30 wt. %, or at least 35 wt. %, or at least 40 wt. % of hydrocarbons having a boiling point of at least 538° C. (1000° F.) as determined in accordance with ASTM Method D7169. The petroleum contained in the petroleum-bearing formation may have an asphaltene content of at least 1 wt. %, or at least 5 wt. %, or at least 10 wt. %.

The subterranean petroleum-bearing formation may further comprise sand and water. The sand may be unconsolidated sand mixed with the petroleum and water in the formation. The petroleum may comprise from 1 wt. % to 20 wt. % of the petroleum/sand/water mixture; the sand may comprise from 70 wt. % to 90 wt. % of the petroleum/sand/water mixture; and water may comprise from 1 wt. % to 20 wt. % of the petroleum/sand/water mixture. The sand may be coated with a layer of water with the petroleum located in the void space around the wetted sand grains. The subterranean petroleum-bearing formation may also include a small volume of gas such as methane or air.

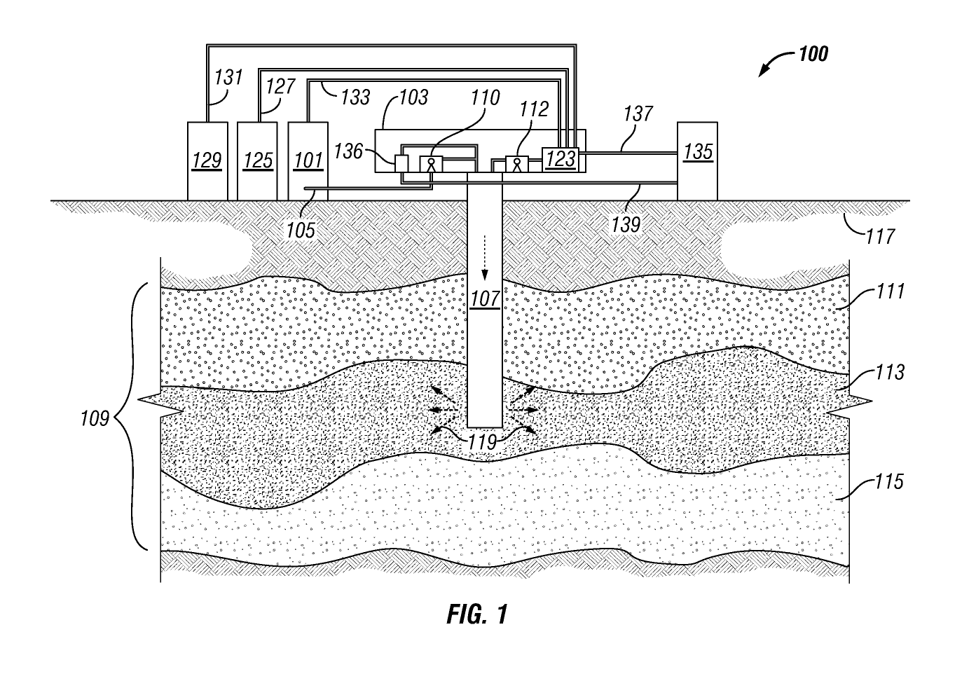

Referring now to FIG. 1, a system of the present invention is shown for practicing a method of the present invention. An oil recovery formulation as described above may be provided in an oil recovery formulation storage facility 101 fluidly operatively coupled to an injection/production facility 103 via conduit 105. Injection/production facility 103 may be fluidly operatively coupled to a well 107, which may be located extending from the injection/production facility 103 into a subterranean petroleum-bearing formation 109 such as described above comprised of one or more formation portions 111, 113, and 115 located beneath an overburden 117. Alternatively, the oil recovery formulation storage facility 101 may be fluidly operatively connected directly to the well 107 for introduction into the formation 109 through the well. As shown by the down arrow in well 107, the oil recovery formulation may flow through the well to be introduced into the formation 109, for example in formation portion 113, where the injection/production facility 103 and the well 107, or the well 107 itself, include(s) a mechanism for introducing the oil recovery formulation into the formation 109. The mechanism for introducing the oil recovery formulation into the formation 109 may be comprised of a pump 110 for delivering the oil recovery formulation to perforations or openings in the well through which the oil recovery formulation may be injected into the formation.

In order to inject the oil recovery formulation into the subterranean petroleum-bearing formation 109, it may be necessary to first establish a fluid flow path in the formation since the unconsolidated sand and the viscous petroleum of the formation may impede injection of the oil recovery formulation into the formation. A fluid flow path may be established in the formation 109 by injecting steam into the formation or by hydraulic fracturing. Steam may be injected to establish a fluid flow path if the injection path from the well into the formation 109 is located in a water saturated zone of the formation 109. The well may have a mechanism for injecting steam into the formation, which may be the same mechanism for injecting the oil recovery formulation into the formation. Any asphaltic or other hydrocarbon materials located in the water saturated zone may be mobilized by the steam, opening a fluid flow path. Alternatively, or in conjunction with injection of steam into the formation 109, hydraulic fracturing may be utilized to establish a fluid flow path from the well into the formation, particularly in hydrocarbon saturated zones of the formation, where the well may include a mechanism for hydraulic fracturing of the formation. Hydraulic fracturing may be effected in accordance with well known hydraulic fracturing techniques. Once a fluid flow path has been established in the formation 109, a propping agent may be injected into the flow path to prevent the flow path from closing, where the well may have a mechanism for injecting a propping agent into an established fluid flow path. Gravel and sand or mixtures thereof may be utilized as propping agents, where the propping agent may have a wide distribution of particle sizes to prevent the tar sand materials in the formation from flowing into and closing the fluid flow path.

Steam may produced in the system of the present for introduction into the formation 109 to establish a fluid flow path. A water tank 135 may be fluidly operatively coupled to the injection/production facility 103 via conduit 139 to provide water to a boiler 136 located in the injection/production facility. The boiler 136 may produce steam for injection into the formation through the well 107.

The pressure at which the steam may be injected into the formation to establish a fluid flow path may range from 20% to 95%, or from 40% to 90%, of the fracture pressure of the formation. The pressure at which the steam may be injected into the formation may range from a pressure of greater than 0 MPa to 37 MPa above the initial formation pressure as measured prior to when the injection of the steam begins. The pressure at which the steam may be injected into the formation may be relatively low when the steam is injected into the formation at a depth of from 75 meters to 200 meters below the surface of the earth to prevent buckling the overburden of the formation. The steam may be injected into a formation located at a depth of from 75 meters to 200 meters below the surface of the earth at a pressure of from the initial formation pressure up to 8.2 MPa (1200 psi) above the initial formation pressure.

The oil recovery formulation is introduced into the formation 109, for example by being injected into the formation by pumping the oil recovery formulation into the formation either with or without previously establishing a fluid flow path as described above. An amount of the oil recovery formulation may be introduced into the formation to form a mobilized mixture of petroleum and the oil recovery formulation. The amount of oil recovery formulation introduced into the formation may be sufficient to form a mobilized mixture of the oil recovery formulation and petroleum that may contain at least 10 vol. %, or at least 20 vol. %, or at least 30 vol. %, or at least 40 vol. %, or at least 50 vol. %, or greater than a 50 vol. % of the oil recovery formulation.

The oil recovery formulation may be introduced into the formation at a pressure above the instantaneous pressure in the formation to force the oil recovery formulation to flow into the formation. The pressure at which the oil recovery formulation is introduced into the formation may range from the instantaneous pressure in the formation up to, but not including, the fracture pressure of the formation. The pressure at which the oil recovery formulation may be injected into the formation may range from 20% to 95%, or from 40% to 90%, of the fracture pressure of the formation. The pressure at which the oil recovery formulation is injected into the formation may range from a pressure of greater than 0 MPa to 37 MPa above the initial formation pressure as measured prior to when the injection of the oil recovery formulation begins. The pressure at which the oil recovery formulation may be injected into the formation may be relatively low when the oil recovery formulation is injected into the formation at a depth of from 75 meters to 200 meters below the surface of the earth to prevent buckling the overburden of the formation. The oil recovery formulation may be injected into a formation located at a depth of from 75 meters to 200 meters below the surface of the earth at a pressure of from the initial formation pressure up to 8.2 MPa (1200 psi) above the initial formation pressure.

In one embodiment of the method and system of the present invention, the oil recovery formulation may be introduced into the formation 109 together with steam to raise the temperature in the formation around the injection point to reduce the viscosity of the petroleum and to thereby promote the mixing of the oil recovery formulation and the petroleum in the formation. In an embodiment of the system and method of the present invention, steam and the oil recovery formulation may be co-injected into the formation 109 through the well 107. The combined co-injected oil recovery formulation and steam may be injected into the formation at pressures as described above with respect to injection of the oil recovery formulation into the formation.

As the oil recovery formulation is introduced into the formation 109, with or without steam, the oil recovery formulation spreads into the formation as shown by arrows 119. Upon introduction to the formation 109, the oil recovery formulation contacts and forms a mixture with a portion of the petroleum in the formation. The oil recovery formulation is first contact miscible with the petroleum in the formation, where the oil recovery formulation mobilizes at least a portion of the petroleum in the formation upon mixing with the petroleum. The oil recovery formulation may mobilize the petroleum in the formation upon mixing with the petroleum, for example, by reducing the viscosity of the mixture relative to the native petroleum in the formation, by reducing the capillary forces retaining the petroleum in the formation, by reducing the wettability of the petroleum on sand surfaces in the formation, and/or by swelling the petroleum in the formation.

The oil recovery formulation may be left to soak in the formation after introduction of the oil recovery formulation into the formation to mix with and mobilize the petroleum in the formation. The oil recovery formulation may be left to soak in the formation for a period of time of from 1 hour to 15 days, preferably from 5 hours to 50 hours.

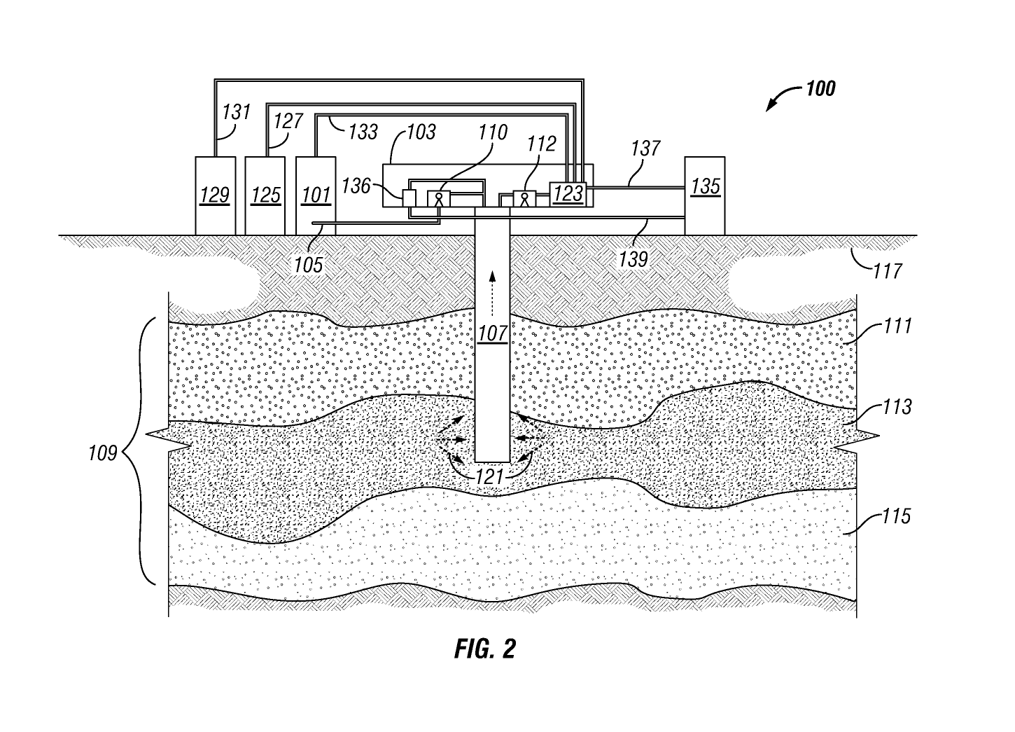

Subsequent to the introduction of the oil recovery formulation into the formation 109 and after the soaking period, petroleum may be recovered and produced from the formation 109, as shown in FIG. 2. Optionally, oil recovery formulation—preferably in a mixture with the petroleum—is also recovered and produced from the formation 109, and optionally gas and water from the formation are also recovered and produced from the formation 109. The system includes a mechanism for producing the petroleum, and may include a mechanism for producing the oil recovery formulation, gas, and water from the formation 109 subsequent to introduction of the oil recovery formulation into the formation, for example, after completion of introduction of the oil recovery formulation into the formation. The mechanism for recovering and producing the petroleum, and optionally the oil recovery formulation, gas and water from the formation 109 may be comprised of a pump 112, which may be located in the injection/production facility 103 and/or within the well 107, and which draws the petroleum, and optionally the oil recovery formulation, gas, and water from the formation to deliver the petroleum, and optionally the oil recovery formulation, gas, and water to the facility 103.

Petroleum, preferably in a mixture with the oil recovery formulation, and optionally mixed with water and formation gas may be drawn from the formation portion 113 as shown by arrows 121 and produced back up the well 107 to the injection/production facility 103. The petroleum may be separated from the oil recovery formulation, water, and gas in a separation unit 123. The separation unit may be comprised of a conventional liquid-gas separator for separating gas from the petroleum, oil recovery formulation, and water; a conventional hydrocarbon-water separator for separating water from petroleum and the oil recovery formulation; and a conventional distillation column for separating the oil recovery formulation from the petroleum or the petroleum and water.

For ease of separation of the produced oil recovery formulation from the produced petroleum, the produced oil recovery formulation may be separated from the petroleum by selective distillation so that the produced oil recovery formulation contains C₃ to C₈, or C₃ to C₆, aliphatic and aromatic hydrocarbons originating from the petroleum produced from the formation and not present in the initial oil recovery formulation. The distillation may be effected so the produced oil recovery formulation has the composition of the original oil recovery formulation plus up to 25 mol % of C₃ to C₈ aliphatic and aromatic hydrocarbons derived from the formation, where the separated produced oil recovery formulation is comprised of at least 75 mol % dimethyl sulfide.

The separated petroleum may be provided from the separation unit 123 of the injection/production facility 103 to a liquid storage tank 125, which may be fluidly operatively coupled to the separation unit of the injection/production facility by conduit 127. The separated gas may be provided from the separation unit 123 of the injection/production facility 103 to a gas storage tank 129, which may be fluidly operatively coupled to the separation unit of the injection/production facility by conduit 131. The separated oil recovery formulation, optionally containing additional C₃ to C₈ or C₃ to C₆ hydrocarbons derived from the petroleum produced from the formation, may be provided from the separation unit 123 of the injection/production facility to the oil recovery formulation storage facility 101, which may be fluidly operatively coupled to the separation unit of the injection/production facility by conduit 133. Alternatively, the separated oil recovery formulation, optionally containing C₃ to C₈ or C₃ to C₆ hydrocarbons derived from the petroleum produced from the formation, may be provided from the separation unit 123 of the injection/production facility 103 to the injection mechanism 110 for reinjection into the formation via the well 107, where the separation unit 123 may be fluidly operatively coupled to the injection mechanism 110 to provide the separated oil recovery formulation from the separation unit 123 to the injection mechanism 110. Separated water may be provided from the separation unit 123 of the injection/production facility 103 to a water tank 135, which may be fluidly operatively coupled to the separation unit of the injection/production facility by conduit 137. The water tank 135 may be fluidly operatively coupled to the boiler 136 in the first injection/production facility 103 for producing steam for co-injection with the oil recovery formulation into the formation.

After recovery and production of at least a portion of the petroleum from the formation 109, and optionally recovering and producing at least a portion of the oil recovery formulation injected into the formation, an additional portion of the oil recovery formulation may be injected into the formation to mobilize at least a portion of the petroleum remaining in the formation for recovery and production. The amount of the additional portion of oil recovery formulation injected into the formation 109 may be increased relative to the amount of oil recovery formulation injected prior to the injection of the additional portion of oil recovery formulation to increase the volume of the formation that is swept by the oil recovery formulation. An additional portion of the petroleum remaining in the formation may be mobilized, recovered, and produced from the well subsequent to injection of the additional portion of the oil recovery formulation in a manner as described above. Subsequent additional portions of oil recovery formulation may be injected into the formation for further recovery and production of petroleum from the formation, as desired.

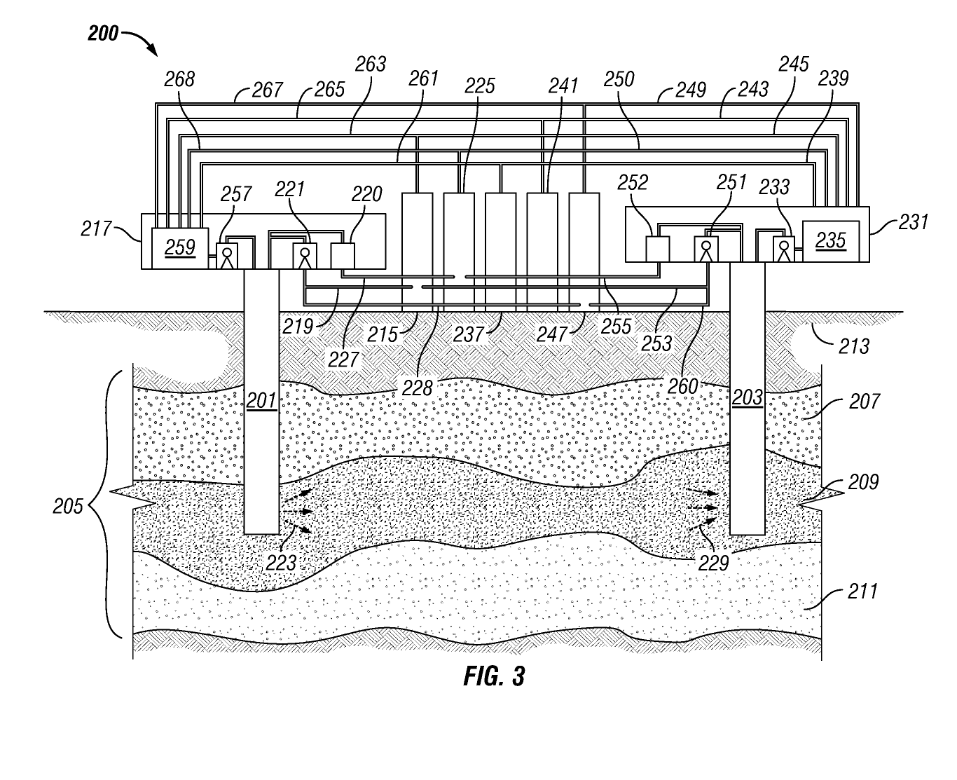

Referring now to FIG. 3, a system of the present invention for practicing a method of the present invention is shown. The system includes a first well 201 and a second well 203 extending into a subterranean petroleum-bearing formation 205 such as described above. The petroleum-bearing formation 205 may be comprised of one or more formation portions 207, 209, and 211 comprised of petroleum having a dynamic viscosity of at least 1000 mPa s (1000 cP) at 25° C. and an API Gravity of at most 20°, unconsolidated sand, and water, such as described above, located beneath an overburden 213. An oil recovery formulation as described above is provided. The oil recovery formulation may be provided from an oil recovery formulation storage facility 215 fluidly operatively coupled to a first injection/production facility 217 via conduit 219. First injection/production facility 217 may be fluidly operatively coupled to the first well 201, which may be located extending from the first injection/production facility 217 into the petroleum-bearing formation 205. The oil recovery formulation may flow from the first injection/production facility 217 through the first well to be introduced into the formation 205, for example in formation portion 209, where the first injection/production facility 217 and the first well, or the first well itself, include(s) a mechanism for introducing the oil recovery formulation into the formation. Alternatively, the oil recovery formulation may be provided from the oil recovery formulation storage facility 215 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 217, or the first well 201, or both—may be comprised of a pump 221 or a compressor for delivering the oil recovery formulation to perforations or openings in the first well through which the oil recovery formulation may be introduced into the formation.

The oil recovery formulation may be introduced into the formation 205, for example by injecting the oil recovery formulation into the formation through the first well 201 by pumping the oil recovery formulation through the first well and into the formation. The pressure at which the oil recovery formulation may be injected into the formation 205 through the first well 201 may be as described above with respect to injection and production using a single well.

A fluid flow path may be established in the formation 205 as described above prior to injecting the oil recovery formulation into the formation. The fluid flow path may be established between the first well 201 and the second well 203 prior to introducing the oil recovery formulation into the formation 205, where steam may be injected into the formation from the first well 201 and/or the second well 203 to establish a fluid flow path between the wells. A water tank 225 may be fluidly operatively coupled to a boiler 220 located in the first injection/production facility 217 via conduit 227 to provide water to the boiler 220 for the production of steam. The boiler 220 may produce steam for injection into the formation 205 through the first well 201. The water tank 225 may be fluidly operatively coupled to a boiler 252 located in a second injection/production facility 231 to provide water to the boiler 252 for the production of steam. The boiler 252 may be fluidly operatively coupled to a mechanism for injecting steam into the formation 205 through the second well 203 to provide pressurized steam to the formation through the second well. Steam may be injected through the first well 201 and/or the second well 203 to establish a fluid flow path in the formation 205 at pressures as described above with respect to injecting steam to establish a fluid flow path from a single well. Proppant, as described above, may be injected into the fluid flow path established in the formation 205 through the first well 201 and/or the second well 203, as described above, to maintain the fluid flow path in the formation.

In an embodiment of the system and method of the present invention, steam and the oil recovery formulation may be co-injected into the formation 205 through the first well 201. The co-injected steam and oil recovery formulation may be injected into the formation at pressures as described above with respect to co-injection of the oil recovery formulation and steam into the formation using a single well. The mixture of steam and oil recovery agent may be injected into a fluid flow path established in the formation 205. Steam may be utilized to raise the temperature in the formation along the flow path between the first well 201 and the second well 203 to reduce the viscosity of petroleum in the formation and thereby promote the mixing of the oil recovery formulation and the petroleum in the formation.

The volume of oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil recovery formulation between the first well 201 and the second well 203. The pore volume may be readily be determined by methods known to a person skilled in the art, for example by modelling studies or by injecting water having a tracer contained therein through the formation 205 from the first well 201 to the second well 203.

As the oil recovery formulation is introduced into the formation 205, the oil recovery formulation spreads into the formation as shown by arrows 223. Upon introduction to the formation 205, the oil recovery formulation contacts and forms a mixture with a portion of the petroleum in the formation. The oil recovery formulation is first contact miscible with the petroleum in the formation 205, where the oil recovery formulation may mobilize the petroleum in the formation upon mixing with the petroleum. The oil recovery formulation may mobilize the petroleum in the formation upon mixing with the petroleum, for example, by reducing the viscosity of the mixture relative to the native petroleum in the formation, by reducing the capillary forces retaining the petroleum in the formation, by reducing the wettability of the petroleum on sand surfaces in the formation, and/or by swelling the petroleum in the formation.

If a fluid flow path has been established in the formation 205 between the first well 201 and the second well 203, the oil recovery formulation may mix with petroleum in the formation adjacent to the flow path to mobilize the petroleum and draw the mobilized petroleum into the flow path where the mixture of the oil recovery formulation and the petroleum may be displaced through the formation from the first well 201 towards the second well 203 along the flow path. As more petroleum is mobilized and removed from the formation the flow path may widen, permitting further production of petroleum adjacent to the widened flow path.

The mobilized mixture of the oil recovery formulation and petroleum and any unmixed oil recovery formulation may be pushed across the formation 205 from the first well 201 to the second well 203 by further introduction of more oil recovery formulation or by introduction of an oil immiscible formulation into the formation subsequent to introduction of the oil recovery formulation into the formation. If a fluid flow path has been established between the first and second wells, the mobilized mixture of the oil recovery formulation and any unmixed oil recovery formulation may be pushed across the formation along the fluid flow path. Any unmixed oil recovery formulation may mix with and mobilize more petroleum in the formation 205 as the unmixed oil recovery formulation is pushed across the formation, and may contact, mix with, and mobilize petroleum adjoining a fluid flow path.

An oil immiscible formulation may be introduced into the formation 205 through the first well 201 after completion of introduction of the oil recovery formulation into the formation to force or otherwise displace the mobilized mixture of the oil recovery formulation and petroleum as well as any unmixed oil recovery formulation toward the second well 203 for production. If a fluid flow path has been established in the formation, the oil immiscible formulation may be introduced into the formation via the fluid flow path to drive mobilized petroleum in the flow path to the second well.

The oil immiscible formulation may be selected to displace the mobilized mixture of oil recovery formulation and petroleum as well as any unmixed oil recovery formulation through the formation 205. Suitable oil immiscible formulations are not first contact miscible or multiple contact miscible with petroleum in the formation and preferably are immiscible with petroleum in the formation 205. The oil immiscible formulation may be selected from the group consisting of an aqueous polymer fluid, water in gas or liquid form, carbon dioxide at a pressure below its minimum miscibility pressure, nitrogen at a pressure below its minimum miscibility pressure, air, and mixtures of two or more of the preceding.

Suitable polymers for use in an aqueous polymer fluid for use in, or as, the oil immiscible formation may include, but are not limited to, polyacrylamides, partially hydrolyzed polyacrylamides, polyacrylates, ethylenic copolymers, biopolymers, carboxymethylcellulose, polyvinyl alcohols, polystyrene sulfonates, polyvinylpyrolidones, AMPS (2-acrylamide-2-methyl propane sulfonate), combinations thereof, or the like. Examples of ethylenic copolymers include copolymers of acrylic acid and acrylamide, acrylic acid and lauryl acrylate, lauryl acrylate and acrylamide. Examples of biopolymers include xanthan gum, guar gum, alginates, alginic acids and salts thereof. In some embodiments, polymers may be crosslinked in situ in the formation 205. In other embodiments, polymers may be generated in situ in the formation 205.

The oil immiscible formulation may be stored in, and provided for introduction into the formation 205 from, an oil immiscible formulation storage facility 247 that may be fluidly operatively coupled to the first injection/production facility 217 via conduit 228. The first injection/production facility 217 may be fluidly operatively coupled to the first well 201 to provide the oil immiscible formulation to the first well for introduction into the formation 205. The first injection/production facility 217 and the first well 201, or the first well itself, may comprise a mechanism for introducing the oil immiscible formulation into the formation 205 via the first well 201. The mechanism for introducing the oil immiscible formulation into the formation 205 via the first well 201 may be comprised of a pump or a compressor for delivering the oil immiscible formulation to perforations or openings in the first well through which the oil immiscible formulation may be injected into the formation. The mechanism for introducing the oil immiscible formulation into the formation 205 via the first well 201 may be the pump 221 utilized to inject the oil recovery formulation into the formation via the first well 201.

The oil immiscible formulation may be introduced into the formation 205, for example, by injecting the oil immiscible formulation into the formation through the first well 201 by pumping the oil immiscible formulation through the first well and into the formation, for example to a fluid flow path established in the formation. The pressure at which the oil immiscible formulation may be injected into the formation 205 through the first well 201 may be up to, but not including, the fracture pressure of the formation, or from 20% to 99%, or from 30% to 95%, or from 40% to 90% of the fracture pressure of the formation. In an embodiment of the present invention, the oil immiscible formulation may be injected into the formation 205 at a pressure from greater than 0 MPa to 37 MPa above the formation pressure as measured prior to injection of the oil immiscible formulation.

The amount of oil immiscible formulation introduced into the formation 205 via the first well 201 following introduction of the oil recovery formulation into the formation via the first well may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil immiscible formulation between the first well and the second well. The amount of oil immiscible formulation introduced into the formation 205 may be sufficient to drive the mobilized petroleum/oil recovery formulation mixture and any unmixed oil recovery formulation across at least a portion of the formation. If the oil immiscible formulation is in liquid phase, the volume of oil immiscible formulation introduced into the formation 205 following introduction of the oil recovery formulation into the formation relative to the volume of oil recovery formulation introduced into the formation immediately preceding introduction of the oil immiscible formulation may range from 0.1:1 to 10:1 of oil immiscible formulation to oil recovery formulation, more preferably from 1:1 to 5:1 of oil immiscible formulation to oil recovery formulation. If the oil immiscible formulation is in gaseous phase, the volume of oil immiscible formulation introduced into the formation 205 following introduction of the oil recovery formulation into the formation relative to the volume of oil recovery formulation introduced into the formation immediately preceding introduction of the oil immiscible formulation may be substantially greater than a liquid phase oil immiscible formulation, for example, at least 10 or at least 20, or at least 50 volumes of gaseous phase oil immiscible formulation per volume of oil recovery formulation introduced immediately preceding introduction of the gaseous phase oil immiscible formulation.

If the oil immiscible formulation is in liquid phase, the oil immiscible formulation may have a viscosity of at least the same magnitude as the viscosity of the mobilized petroleum/oil recovery formulation mixture at formation temperature conditions to enable the oil immiscible formulation to drive the mixture of mobilized petroleum/oil recovery formulation across the formation 205 to the second well 203. The oil immiscible formulation may have a viscosity of at least 0.8 mPa s (0.8 cP) or at least 10 mPa s (10 cP), or at least 50 mPa s (50 cP), or at least 100 mPa s (100 cP), or at least 500 mPa s (500 cP), or at least 1000 mPa s (1000 cP) at formation temperature conditions. If the oil immiscible formulation is in liquid phase, preferably the oil immiscible formulation has a viscosity at least one order of magnitude greater than the viscosity of the mobilized petroleum/oil recovery formulation mixture at formation temperature conditions so the oil immiscible formulation may drive the mobilized petroleum/oil recovery formulation mixture across the formation in plug flow, minimizing and inhibiting fingering of the mobilized petroleum/oil recovery formulation mixture through the driving plug of oil immiscible formulation.

The oil recovery formulation and the oil immiscible formulation may be introduced into the formation through the first well 201 in alternating slugs. For example, the oil recovery formulation may be introduced into the formation 205 through the first well 201 for a first time period, after which the oil immiscible formulation may be introduced into the formation through the first well for a second time period subsequent to the first time period, after which the oil recovery formulation may be introduced into the formation through the first well for a third time period subsequent to the second time period, after which the oil immiscible formulation may be introduced into the formation through the first well for a fourth time period subsequent to the third time period. As many alternating slugs of the oil recovery formulation and the oil immiscible formulation may be introduced into the formation through the first well as desired.

Petroleum may be mobilized for production from the formation 205 via the second well 203 by introduction of the oil recovery formulation, and optionally the oil immiscible formulation, into the formation, where the mobilized petroleum is driven through the formation for production from the second well as indicated by arrows 229, optionally along a fluid flow path, by introduction of the oil recovery formulation, and optionally the oil immiscible formulation, into the formation via the first well 201. The petroleum mobilized for production from the formation 205 may include the mobilized petroleum/oil recovery formulation mixture. Water and/or gas may also be mobilized for production from the formation 205 via the second well 203 by introduction of the oil recovery formulation into the formation via the first well 201.

After introduction of the oil recovery formulation into the formation 205 via the first well 201, petroleum may be recovered and produced from the formation via the second well 203. The system may include a mechanism located at the second well for recovering and producing the petroleum from the formation 205 subsequent to introduction of the oil recovery formulation into the formation, and may include a mechanism located at the second well for recovering and producing the oil recovery formulation, the oil immiscible formulation, water, and/or gas from the formation subsequent to introduction of the oil recovery formulation into the formation. The mechanism located at the second well 203 for recovering and producing the petroleum, and optionally for recovering and producing the oil recovery formulation, the oil immiscible formulation, water, and/or gas may be comprised of a pump 233, which may be located in the second injection/production facility 231 and/or within the second well 203. The pump 233 may draw the petroleum, and optionally the oil recovery formulation, the oil immiscible formulation, water, and/or gas from the formation 205 through perforations in the second well 203 to deliver the petroleum, and optionally the oil recovery formulation, the oil immiscible formulation, water, and/or gas, to the second injection/production facility 231.

Petroleum, optionally in a mixture with the oil recovery formulation, oil immiscible formulation, water, and/or gas may be drawn from the formation 205 as shown by arrows 229 and produced up the second well 203 to the second injection/production facility 231. The petroleum may be separated from the oil recovery formulation, oil immiscible formulation (if any), gas, and/or water in a separation unit 235 located in the second injection/production facility 231. The separation unit 235 may be comprised of a conventional liquid-gas separator for separating gas from the petroleum, oil recovery formulation, water, and oil immiscible formulation; a conventional hydrocarbon-water separator for separating the petroleum and oil recovery formulation from water and the oil immiscible formulation; and a conventional distillation column for separating the oil recovery formulation from the petroleum; and optionally a separator for separating liquid oil immiscible formulation from water. As discussed above, for ease of separation, distillation conditions may be selected to separate the oil recovery formulation from the petroleum such that the oil recovery formulation includes C₃ to C₈, or C₃ to C₆, aliphatic and aromatic hydrocarbons originating from the petroleum.

The separated petroleum may be provided from the separation unit 235 of the second injection/production facility 231 to a liquid storage tank 237, which may be fluidly operatively coupled to the separation unit 235 of the second injection/production facility by conduit 239. The separated gas, if any, may be provided from the separation unit 235 of the second injection/production facility 231 to a gas storage tank 241, which may be fluidly operatively coupled to the separation unit 235 of the second injection/production facility 231 by conduit 243. The separated produced oil recovery formulation, optionally containing additional C₃ to C₈ or C₃ to C₆ hydrocarbons, may be provided from the separation unit 235 of the second injection/production facility 231 to the oil recovery formulation storage unit 215, which may be fluidly operatively coupled to the separation unit 235 of the second injection/production facility 231 by conduit 245. The separated produced oil recovery formulation may be re-injected into the formation 205 for further mobilization and recovery of petroleum from the formation. Separated water may be provided from the separation unit 235 of the second injection/production facility 231 to the water tank 225, which may be fluidly operatively coupled to the separation unit 235 of the second injection/production facility 231 by conduit 250. The separated water may be provided to the boiler 220 or the boiler 252 for production of steam for re-injection into the formation, optionally after removing sediments by filtration and/or ultrafiltration and/or de-ionizing the water by nanofiltration or reverse osmosis. Separated produced oil immiscible formulation may be provided from the separation unit 235 of the second injection/production facility 231 to the oil immiscible formulation storage facility 247 by conduit 249. The separated produced oil immiscible formulation may be provided from the oil immiscible formulation storage facility 247 for re-injection into the formation.

In an embodiment of a system and a method of the present invention, the first well 201 may be used for injecting the oil recovery formulation into the formation 205 to mobilize petroleum in the formation and the second well 203 may be used to produce petroleum from the formation for a first time period, and the second well 203 may be used for injecting the oil recovery formulation into the formation 205 to mobilize the petroleum in the formation and the first well 201 may be used to produce petroleum for a second time period, where the second time period is subsequent to the first time period. The second injection/production facility 231 may comprise a mechanism such as pump 251 that is fluidly operatively coupled the oil recovery formulation storage facility 215 by conduit 253 and that is fluidly operatively coupled to the second well 203 to introduce the oil recovery formulation into the formation 205 via the second well. Alternatively, the oil recovery formulation storage facility 215 may be fluidly operatively coupled directly to the second well 203, where the second well comprises a mechanism to inject the oil recovery formulation into the formation. If steam is to be co-injected into the formation with the oil recovery formulation or is to be utilized to establish a fluid flow path in the formation from the second well 203 to the first well 201 prior to introduction of the oil recovery formulation into the formation, the second injection/production facility may comprise a boiler 252 that is fluidly operatively coupled to the water tank 225 via conduit 255 and that is fluidly operatively coupled to the second well, where the second well comprises a mechanism to introduce steam from the boiler into the formation, optionally together with the oil recovery formulation. The pump 251 or a compressor may also be fluidly operatively coupled to the oil immiscible formulation storage facility 247 by conduit 260 and fluidly operatively connected to the second well 203 to introduce the oil immiscible formulation into the formation 205 via the second well 203 subsequent to introduction of the oil recovery formulation into the formation via the second well. The first injection/production facility 217 may comprise a mechanism such as pump 257 for production of petroleum, and optionally the oil recovery formulation, oil immiscible formulation, water, and/or gas from the formation 205 via the first well 201. The first injection/production facility 217 may also include a separation unit 259 for separating petroleum, the oil recovery formulation, water, oil immiscible formulation, and/or gas. The separation unit 259 may be comprised of a conventional liquid-gas separator for separating gas from the petroleum, oil recovery formulation, water, and oil immiscible formulation; a conventional hydrocarbon-water separator for separating the petroleum and oil recovery formulation from water and the oil immiscible formulation; a conventional distillation column for separating the oil recovery formulation—optionally in combination with C₃ to C₈, or C₃ to C₆, aliphatic and aromatic hydrocarbons derived from the produced petroleum—from the petroleum; and optionally a separator for separating liquid oil immiscible formulation from water.

The separation unit 259 may be fluidly operatively coupled to: the liquid storage tank 237 by conduit 261 for storage of produced petroleum in the liquid storage tank; the oil recovery formulation storage facility 215 by conduit 263 for storage of the recovered oil recovery formulation in the oil recovery formulation storage facility 215; the gas storage tank 241 by conduit 265 for storage of produced gas in the gas storage tank; the oil immiscible formulation storage facility 247 by conduit 267 for storage of recovered oil immiscible formulation; and the water tank 225 by conduit 268 for storage of produced water in the water tank.

The first well 201 may be used for introducing the oil recovery formulation, with or without steam—and, optionally, subsequent to introduction of the oil recovery formulation via the first well, the oil immiscible formulation—into the formation 205, and the second well 203 may be used for producing petroleum from the formation for a first time period; then the second well 203 may be used for injecting the oil recovery formulation, with or without steam—and, optionally, subsequent to introduction of the oil recovery formulation via the second well, the oil immiscible formulation—into the formation 205, and the first well 201 may be used for producing petroleum from the formation for a second time period, where the first and second time periods comprise a cycle. Multiple cycles may be conducted which include alternating the first well 201 and the second well 203 between introducing the oil recovery formulation into the formation 205—and, optionally introducing the oil immiscible formulation into the formation subsequent to introduction of the oil recovery formulation—and producing petroleum from the formation, where one well is injecting and the other is producing for the first time period, and then they are switched for a second time period. A cycle may be from about 12 hours to about 1 year, or from about 3 days to about 6 months, or from about 5 days to about 3 months. In some embodiments, the oil recovery formulation may be introduced into the formation at the beginning of a cycle, and an oil immiscible formulation may be introduced at the end of the cycle. In some embodiments, the beginning of a cycle may be the first 10% to about 80% of a cycle, or the first 20% to about 60% of a cycle, the first 25% to about 40% of a cycle, and the end may be the remainder of the cycle.

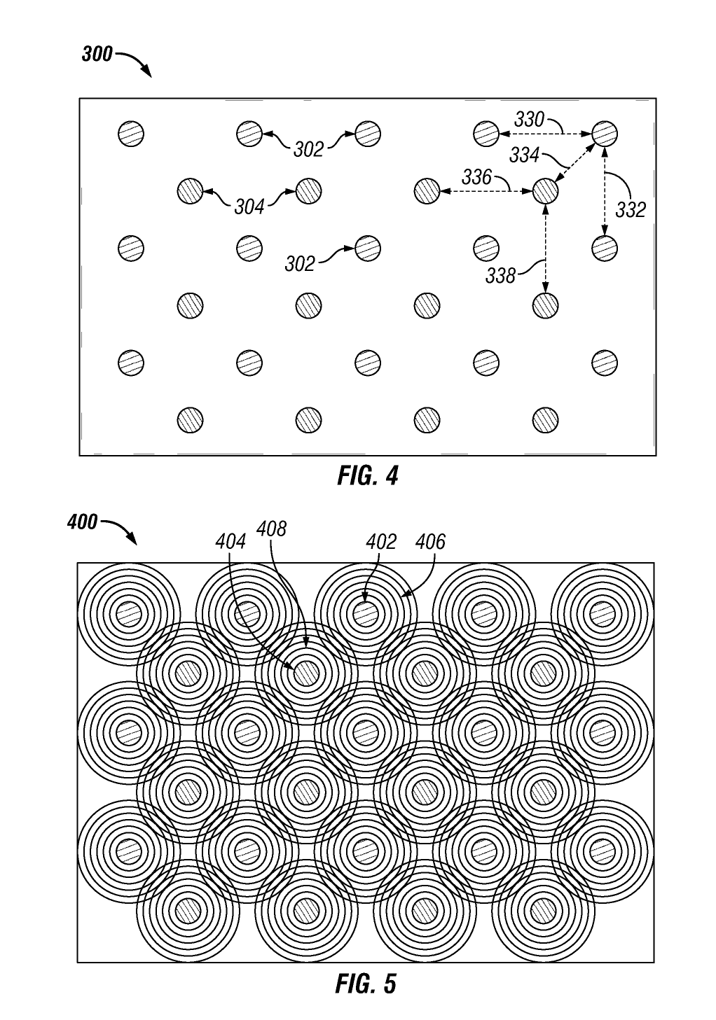

Referring now to FIG. 4, an array of wells 300 is illustrated. Array 300 includes a first well group 302 (denoted by horizontal lines) and a second well group 304 (denoted by diagonal lines). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the first well group 302 may be a vertical distance 332 from an adjacent well in the first well group 302. The vertical distance 332 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the second well group 304 may be a horizontal distance 336 from an adjacent well in the second well group 304. The horizontal distance 336 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the second well group 304 may be a vertical distance 338 from an adjacent well in the second well group 304. The vertical distance 338 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from about 10 to about 1000 wells, for example from about 5 to about 500 wells in the first well group 302, and from about 5 to about 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the subterranean formation with the first well group 302 and the second well group 304 being horizontal wells spaced within the formation, where the second well group 304 is comprised of second wells located below the first wells of the first well group 302.

Referring now to FIG. 5, an array of wells 400 is illustrated. Array 400 includes a first well group 402 (denoted by horizontal lines) and a second well group 404 (denoted by diagonal lines). The array 400 may be an array of wells as described above with respect to array 300 in FIG. 4. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The oil recovery formulation, and optionally steam, optionally followed by an oil immiscible formulation, may be injected into first well group 402, and petroleum may be recovered and produced from the second well group 404. As illustrated, the oil recovery formulation may have an injection profile 406, and petroleum may be produced from the second well group 404 having an oil recovery profile 408. In an embodiment of the method of the present invention, a fluid flow path may be established between one or more wells of the first well group 402 and one or more wells of the second well group 404, and the oil recovery profile may follow the flow path.

The oil recovery formulation, and optionally steam, optionally followed by an oil immiscible formulation, may be injected into the second well group 404, and petroleum may be produced from the first well group 402. As illustrated, the oil recovery formulation may have an injection profile 408, and the petroleum may be produced from the first well group 402 having an oil recovery profile 406. In an embodiment of the method of the present invention, a fluid flow path may be established between one or more wells of the second well group 404 and one or more wells of the first well group 402, and the oil recovery profile may follow the flow path.

The first well group 402 may be used for injecting the oil recovery formulation, and optionally steam, optionally followed by an oil immiscible formulation, and the second well group 404 may be used for producing petroleum from the formation for a first time period; then second well group 404 may be used for injecting the oil recovery formulation, and optionally steam, optionally followed by an oil immiscible formulation, and the first well group 402 may be used for producing petroleum from the formation for a second time period, where the first and second time periods comprise a cycle. In some embodiments, multiple cycles may be conducted which include alternating first and second well groups 402 and 404 between injecting the oil recovery formulation, and producing petroleum and/or gas from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### Example 1

The quality of dimethyl sulfide as an oil recovery agent based on the miscibility of dimethyl sulfide with a crude oil relative to other compounds was evaluated. The miscibility of dimethyl sulfide, ethyl acetate, o-xylene, carbon disulfide, chloroform, dichloromethane, tetrahydrofuran, and pentane solvents with Muskeg River mined oil sands was measured by extracting the oil sands with the solvents at 10° C. and at 30° C. to determine the fraction of hydrocarbons extracted from the oil sands by the solvents. The bitumen content of the Muskeg River mined oil sands was measured at 11 wt. % as an average of bitumen extraction yield values for solvents known to effectively extract substantially all of bitumen from oil sands—in particular chloroform, dichloromethane, o-xylene, tetrahydrofuran, and carbon disulfide. One oil sands sample per solvent per extraction temperature was prepared for extraction, where the solvents used for extraction of the oil sands samples were dimethyl sulfide, ethyl acetate, o-xylene, carbon disulfide, chloroform, dichloromethane, tetrahydrofuran, and pentane. Each oil sands sample was weighed and placed in a cellulose extraction thimble that was placed on a porous polyethylene support disk in a jacketed glass cylinder with a drip rate control valve. Each oil sands sample was then extracted with a selected solvent at a selected temperature (10° C. or 30° C.) in a cyclic contact and drain experiment, where the contact time ranged from 15 to 60 minutes. Fresh contacting solvent was applied and the cyclic extraction repeated until the fluid drained from the apparatus became pale brown in color.

The extracted fluids were stripped of solvent using a rotary evaporator and thereafter vacuum dried to remove residual solvent. The recovered bitumen samples all had residual solvent present in the range of from 3 wt. % to 7 wt. %. The residual solids and extraction thimble were air dried, weighed, and then vacuum dried. Essentially no weight loss was observed upon vacuum drying the residual solids, indicating that the solids did not retain either extraction solvent or easily mobilized water. Collectively, the weight of the solid or sample and thimble recovered after extraction plus the quantity of bitumen recovered after extraction divided by the weight of the initial oil sands sample plus the thimble provide the mass closure for the extractions. The calculated percent mass closure of the samples was slightly high because the recovered bitumen values were not corrected for the 3 wt. % to 7 wt. % residual solvent. The extraction experiment results are summarized in Table 1.

TABLE 1
Summary of Extraction Experiments of Bituminous Oil Sands with Various Fluids

| | | Input | Output | | | Experimental |
|---|---|---|---|---|---|---|
| | | Solids | Solids | Weight | Recovered | Weight |
| Extraction Fluid | Temperature, C. | weight, g | weight, g | Change, g | Bitumen, g | Closure, % |
| Carbon Disulfide | 30 | 151.1 | 134.74 | 16.4 | 16.43 | 100.0 |
| Carbon Disulfide | 10 | 151.4 | 134.62 | 16.8 | 16.62 | 99.9 |
| Chloroform | 30 | 153.7 | 134.3 | 19.4 | 18.62 | 99.5 |
| Chloroform | 10 | 156.2 | 137.5 | 18.7 | 17.85 | 99.5 |
| Dichloromethane | 30 | 155.8 | 138.18 | 17.7 | 16.30 | 99.1 |
| Dichloromethane | 10 | 155.2 | 136.33 | 18.9 | 17.66 | 99.2 |
| o-Xylene | 30 | 156.1 | 136.58 | 19.5 | 17.37 | 98.6 |
| o-Xylene | 10 | 154.0 | 136.66 | 17.3 | 17.36 | 100.0 |
| Tetrahydrofuran | 30 | 154.7 | 136.73 | 18.0 | 17.67 | 99.8 |
| Tetrahydrofuran | 10 | 154.7 | 136.98 | 17.7 | 16.72 | 99.4 |
| Ethyl Acetate | 30 | 153.5 | 135.81 | 17.7 | 11.46 | 96.0 |
| Ethyl Acetate | 10 | 155.7 | 144.51 | 11.2 | 10.32 | 99.4 |
| Pentane | 30 | 154.0 | 139.11 | 14.9 | 13.49 | 99.1 |
| Pentane | 10 | 152.7 | 138.65 | 14.1 | 13.03 | 99.3 |
| Dimethyl Sulfide | 30 | 154.2 | 137.52 | 16.7 | 16.29 | 99.7 |
| Dimethyl Sulfide | 10 | 151.7 | 134.77 | 16.9 | 16.55 | 99.7 |

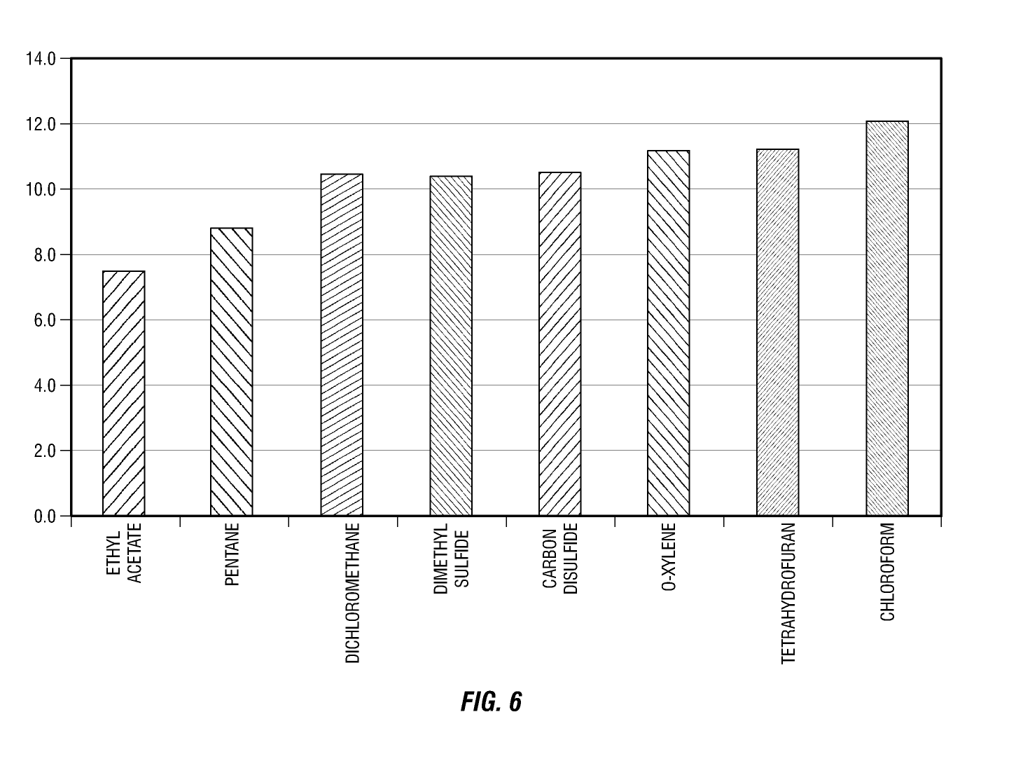

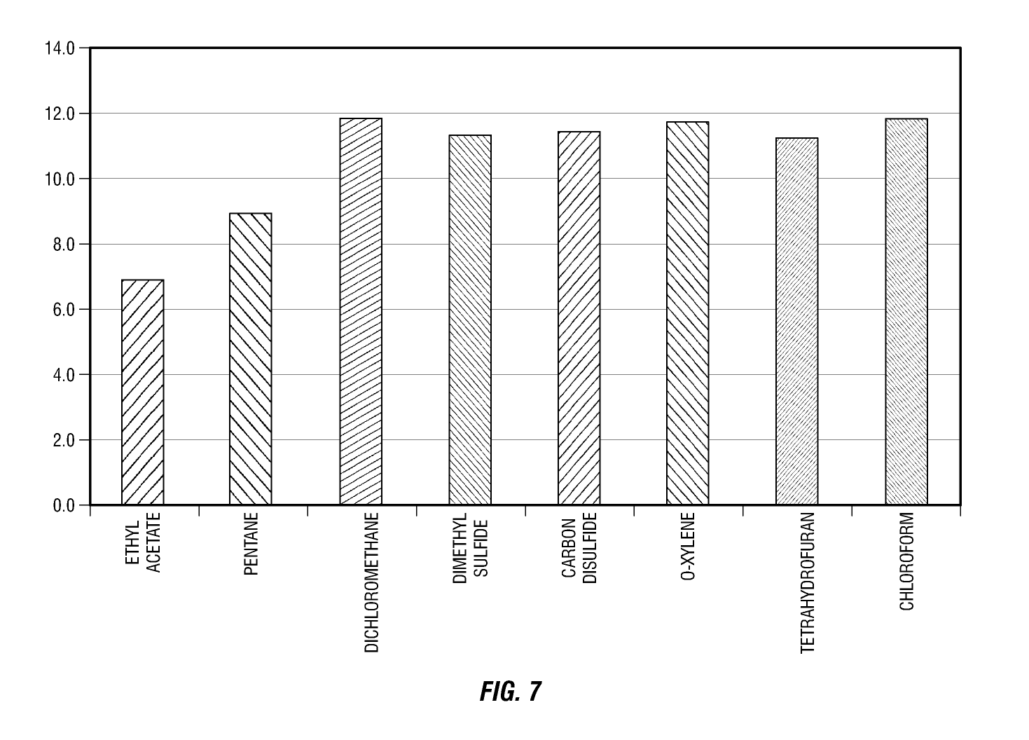

FIG. 6 provides a graph plotting the weight percent yield of extracted bitumen as a function of the extraction fluid at 30° C. applied with a correction factor for residual extraction fluid in the recovered bitumen, and FIG. 7 provides a similar graph for extraction at 10° C. without a correction factor. FIGS. 6 and 7 and Table 1 show that dimethyl sulfide is comparable for recovering bitumen from an oil sand material with the best known fluids for recovering bitumen from an oil sand material—o-xylene, chloroform, carbon disulfide, dichloromethane, and tetrahydrofuran—and is significantly better than pentane and ethyl acetate.

The bitumen samples extracted at 30° C. from each oil sands sample were evaluated by SARA analysis to determine the saturates, aromatics, resins, and asphaltenes composition of the bitumen samples extracted by each solvent. The results are shown in Table 2.

TABLE 2
SARA Analysis of Extracted Bitumen Samples
as a Function of Extraction Fluid

| | Oil Composition Normalized Weight Percent | | | |
|---|---|---|---|---|
| Extraction Fluid | Saturates | Aromatics | Resins | Asphaltenes |
| Ethyl Acetate | 21.30 | 53.72 | 22.92 | 2.05 |
| Pentane | 22.74 | 54.16 | 22.74 | 0.36 |
| Dichloromethane | 15.79 | 44.77 | 24.98 | 14.45 |
| Dimethyl Sulfide | 15.49 | 47.07 | 24.25 | 13.19 |
| Carbon Disulfide | 18.77 | 41.89 | 25.49 | 13.85 |
| o-Xylene | 17.37 | 46.39 | 22.28 | 13.96 |
| Tetrahydrofuran | 16.11 | 45.24 | 24.38 | 14.27 |
| Chloroform | 15.64 | 43.56 | 25.94 | 14.86 |

The SARA analysis showed that pentane and ethyl acetate were much less effective for extraction of asphaltenes from oil sands than are the known highly effective bitumen extraction fluids dichloromethane, carbon disulfide, o-xylene, tetrahydrofuran, and chloroform. The SARA analysis also showed that dimethyl sulfide has excellent miscibility properties for even the most difficult hydrocarbons—asphaltenes.

The data showed that dimethyl sulfide is generally as good as the recognized very good bitumen extraction fluids for recovery of bitumen from oil sands, and is highly compatible with saturates, aromatics, resins, and asphaltenes.

### Example 2

The quality of dimethyl sulfide as an oil recovery agent based on the crude oil viscosity lowering properties of dimethyl sulfide was evaluated. Three crude oils having widely disparate viscosity characteristics—an African Waxy crude, a Middle Eastern asphaltic crude, and a Canadian asphaltic crude—were blended with dimethyl sulfide. Some properties of the three crudes are provided in Table 3.

TABLE 3
Crude Oil Properties

| | | Middle | |
|---|---|---|---|
| | African | Eastern | Canadian |
| | Waxy | Asphaltic | Asphaltic |
| | crude | crude | Crude |
| Hydrogen (wt. %) | 13.21 | 11.62 | 10.1 |
| Carbon (wt. %) | 86.46 | 86.55 | 82 |
| Oxygen (wt. %) | na | na | 0.62 |
| Nitrogen (wt. %) | 0.166 | 0.184 | 0.37 |
| Sulfur (wt. %) | 0.124 | 1.61 | 6.69 |
| Nickel (ppm wt.) | 32 | 14.2 | 70 |
| Vanadium (ppm wt.) | 1 | 11.2 | 205 |
| microcarbon residue (wt. %) | na | 8.50 | 12.5 |
| C₅ Asphaltenes (wt. %) | <0.1 | na | 16.2 |
| C₇ Asphaltenes (wt. %) | <0.1 | na | 10.9 |
| Density (g/ml) (15.6° C.) | 0.88 | 0.9509 | 1.01 |
| API Gravity (15.6° C.) | 28.1 | 17.3 | 8.5 |
| Water (Karl Fisher Titration) (wt. %) | 1.65 | <0.1 | <0.1 |
| TAN-E (ASTM D664) (mg KOH/g) | 1.34 | 4.5 | 3.91 |
| Volatiles Removed by Topping, wt % | 21.6 | 0 | 0 |
| Saturates in Topped Fluid, wt. % | 60.4 | 41.7 | 12.7 |
| Aromatics in Topped Fluid, wt. % | 31.0 | 40.5 | 57.1 |
| Resin in Topped Fluid, wt. % | 8.5 | 14.5 | 17.1 |
| Asphaltenes in Topped Fluid, wt. % | 0.1 | 3.4 | 13.1 |

Boiling Range Distribution

| | | | |
|---|---|---|---|
| Initial Boiling Point - 204° C. (wt. %) | 8.5 | 3.0 | 0 |
| 204° C. (400° F.) - 260° C. (wt. %) | 9.5 | 5.8 | 1.0 |
| 260° C. (500° F.) - 343° C. (wt. %) | 16.0 | 14.0 | 14.0 |
| 343° C. (650° F.) - 538° C. (wt. %) | 39.5 | 42.9 | 38.0 |
| >538° C. (wt. %) | 26.5 | 34.3 | 47.0 |

A control sample of each crude was prepared containing no dimethyl sulfide, and samples of each crude were prepared and blended with dimethyl sulfide to prepare crude samples containing increasing concentrations of dimethyl sulfide. Each sample of each of the crudes was heated to 60° C. to dissolve any waxes therein and to permit weighing of a homogeneous liquid, weighed, allowed to cool overnight, then blended with a selected quantity of dimethyl sulfide. The samples of the crude/dimethyl sulfide blend were then heated to 60° C. and mixed to ensure homogeneous blending of the dimethyl sulfide in the samples. Absolute (dynamic) viscosity measurements of each of the samples were taken using a rheometer and a closed cup sensor assembly. Viscosity measurements of each of the samples of the West African waxy crude and the Middle Eastern asphaltic crude were taken at 20° C., 40° C., 60° C., 80° C., and then again at 20° C. after cooling from 80° C., where the second measurement at 20° C. is taken to measure the viscosity without the presence of waxes since wax formation occurs slowly enough to permit viscosity measurement at 20° C. without the presence of wax. Viscosity measurements of each of the samples of the Canadian asphaltic crude were taken at 5° C., 10° C., 20° C., 40° C., 60° C., 80° C., The measured viscosities for each of the crudes are shown in Tables 4, 5, and 6 below.

TABLE 4
Viscosity (mPa s) of West African Waxy Crude vs. Temperature
at Various levels of Dimethyl Sulfide Diluent

| DMS, wt. % | 20° C. | 40° C. | 60° C. | 80° C. | 20° C. |
|---|---|---|---|---|---|
| 0.00 | 128.8 | 34.94 | 15.84 | 9.59 | 114.4 |
| 1.21 | 125.8 | 30.94 | 14.66 | 8.92 | 100.1 |
| 2.48 | 122.3 | 30.53 | 13.66 | 8.44 | 89.23 |
| 5.03 | 78.37 | 20.24 | 10.45 | 6.55 | 55.21 |
| 7.60 | 60.92 | 17.08 | 9.29 | 6.09 | 40.89 |
| 9.95 | 44.70 | 13.03 | 7.58 | 5.04 | 30.61 |
| 15.13 | 23.96 | 8.32 | 4.97 | 3.38 | 17.64 |
| 19.30 | 15.26 | 6.25 | 4.05 | 2.92 | 12.06 |

TABLE 5
Viscosity (mPa s) of Middle Eastern Asphaltic Crude vs. Temperature
at Various levels of Dimethyl Sulfide Diluent

| DMS, wt. % | 20° C. | 40° C. | 60° C. | 80° C. | 20° C. |
|---|---|---|---|---|---|
| 0.00 | 2936.3 | 502.6 | 143.6 | 56.6 | 2922.7 |
| 1.3 | 1733.8 | 334.5 | 106.7 | 44.6 | 1624.8 |
| 2.6 | 1026.6 | 219.9 | 76.5 | 34.3 | 881.1 |
| 5.3 | 496.5 | 134.2 | 52.2 | 25.5 | 503.5 |
| 7.6 | 288.0 | 89.4 | 37.4 | 19.3 | 290.0 |
| 10.1 | 150.0 | 52.4 | 24.5 | 13.5 | 150.5 |
| 15.2 | 59.4 | 25.2 | 13.6 | 8.2 | 60.7 |
| 20.1 | 29.9 | 14.8 | 8.7 | 5.7 | 31.0 |

TABLE 6
Viscosity (mPa s) of Topped Canadian Asphaltic Crude vs.
Temperature at Various levels of Dimethyl Sulfide Diluent

| DMS, wt. % | 5° C. | 10° C. | 20° C. | 40° C. | 60° C. | 80° C. |
|---|---|---|---|---|---|---|
| 0.00 | | | 579804 | 28340 | 3403 | 732 |
| 1.43 | | | 212525 | 14721 | 2209 | 538 |
| 2.07 | | | 134880 | 10523 | 1747 | 427 |
| 4.87 | | | 28720 | 3235 | 985 | 328 |
| 8.01 | | | 5799 | 982 | 275 | 106 |
| 9.80 | | | 2760 | 571 | 173 | 73 |
| 14.81 | 1794 | 1155 | 548 | 159 | 64 | 32 |
| 19.78 | | | 188 | 69 | 33 | 19 |
| 29.88 | 113 | 81 | 51 | 22 | 13 | 8 |
| 39.61 | 23 | 20 | 14 | 8 | 6 | 4 |

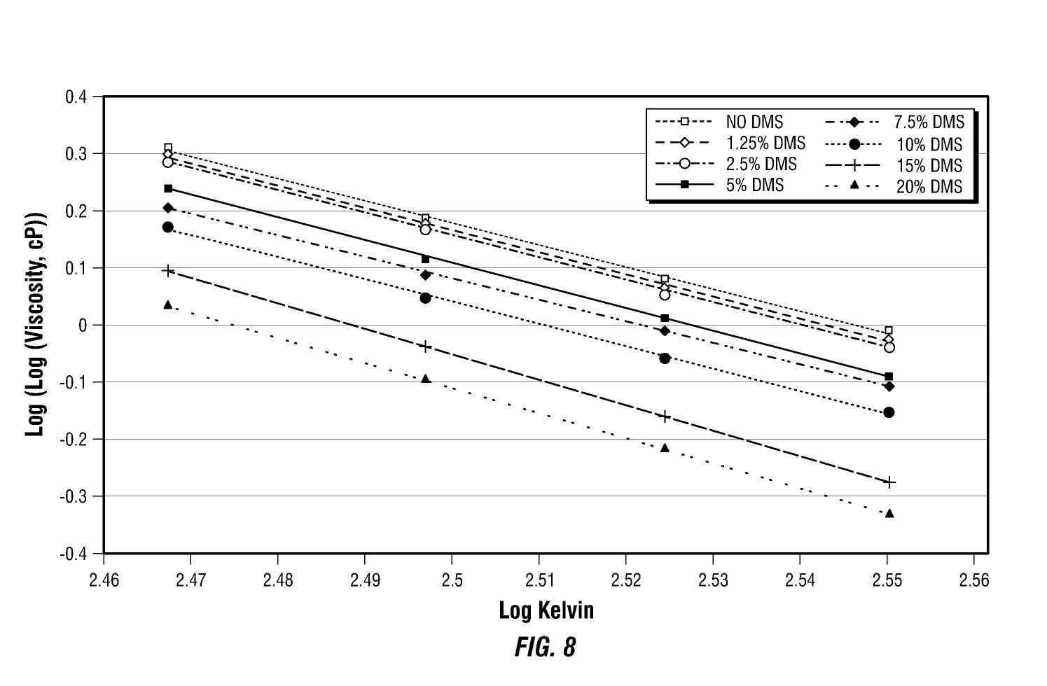

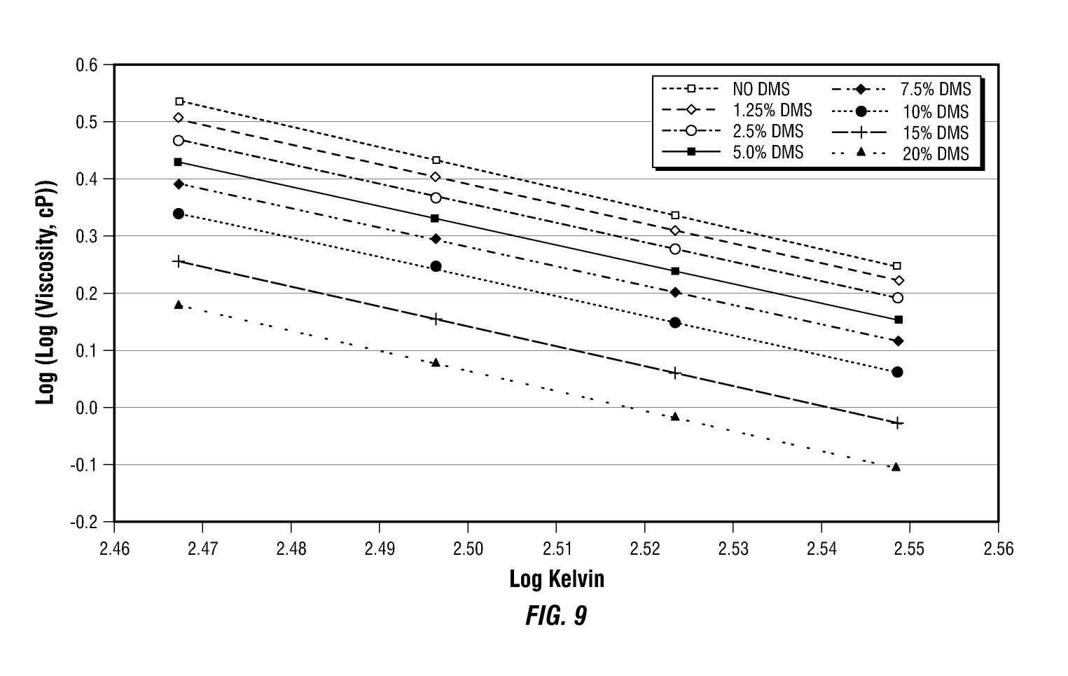

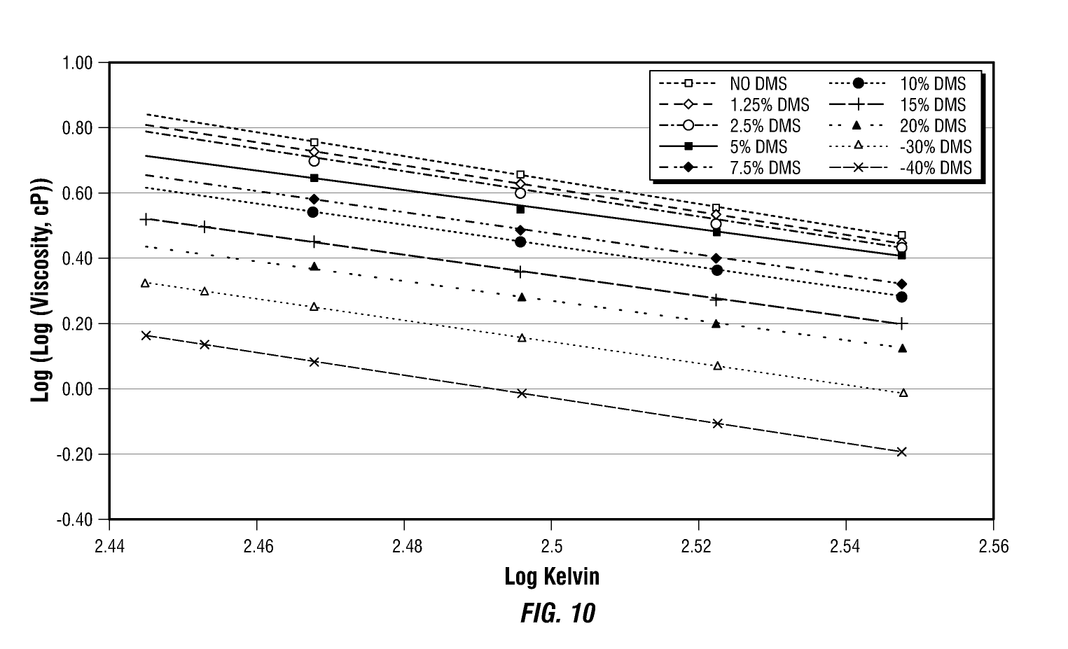

FIGS. 8, 9, and 10 show plots of Log/Log(Viscosity)] v. Log [Temperature ° K] derived from the measured viscosities in Tables 4, 5, and 6, respectively, illustrating the effect of increasing concentrations of dimethyl sulfide in lowering the viscosity of the crude samples.

The measured viscosities and the plots show that dimethyl sulfide is effective for significantly lowering the viscosity of a crude oil over a wide range of initial crude oil viscosities.

### Example 3

Incremental recovery of oil from a formation core using an oil recovery formulation consisting of dimethyl sulfide following oil recovery from the core by water-flooding was measured to evaluate the effectiveness of DMS as a tertiary oil recovery agent.

Two 5.02 cm long Berea sandstone cores with a core diameter of 3.78 cm and a permeability between 925 and 1325 mD were saturated with a brine having a composition as set forth in Table 7.

TABLE 7
Brine Composition

| | Chemical component | | | | | |
|---|---|---|---|---|---|---|
| | CaCl₂ | MgCl₂ | KCl | NaCl | Na₂SO₄ | NaHCO₃ |
| Concentration | 0.386 | 0.523 | 1.478 | 28.311 | 0.072 | 0.181 |
| (kppm) | | | | | | |

After saturation of the cores with brine, the brine was displaced by a Middle Eastern Asphaltic crude oil having the characteristics as set forth above in Table 3 to saturate the cores with oil.

Oil was recovered from each oil saturated core by the addition of brine to the core under pressure and by subsequent addition of DMS to the core under pressure. Each core was treated as follows to determine the amount of oil recovered from the core by addition of brine followed by addition of DMS. Oil was initially displaced from the core by addition of brine to the core under pressure. A confining pressure of 1 MPa was applied to the core during addition of the brine, and the flow rate of brine to the core was set at 0.05 ml/min. The core was maintained at a temperature of 50° C. during displacement of oil from the core with brine. Oil was produced and collected from the core during the displacement of oil from the core with brine until no further oil production was observed (24 hours). After no further oil was displaced from the core by the brine, oil was displaced from the core by addition of DMS to the core under pressure. DMS was added to the core at a flow rate of 0.05 ml/min for a period of 32 hours for the first core and for a period of 15 hours for the second core. Oil displaced from the each core during the addition of DMS to the core was collected separately from the oil displaced by the addition of brine to the core.

The oil samples collected from each core by brine displacement and by DMS displacement were isolated from water by extraction with dichloromethane, and the separated organic layer was dried over sodium sulfate. After evaporation of volatiles from the separated, dried organic layer of each oil sample, the amount of oil displaced by brine addition to a core and the amount of oil displaced by DMS addition to the core were weighed. Volatiles were also evaporated from a sample of the Middle Eastern asphaltic oil to be able to correct for loss of light-end compounds during evaporation. Table 8 shows the amount of oil produced from each core by brine displacement followed by DMS displacement.

TABLE 8

| | | | | Oil produced |
|---|---|---|---|---|
| | | Oil produced | | DMS |
| | Oil produced | Brine | Oil produced | displacement |
| | Brine | displacement | DMS | (of % oil |
| | displacement | (of % oil initially | displacement | initially |
| | (ml) | in core) | (ml) | in core) |
| Core 1 | 4.9 | 45 | 3.5 | 32 |
| Core 2 | 5.0 | 45 | 3.3 | 30 |

As shown in Table 8, DMS is quite effective for recovering an incremental quantity of oil from a formation core after recovery of oil from the core by waterflooding with a brine solution—recovering approximately 60% of the oil remaining in the core after the waterflood.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

What is claimed is:

1. A method for recovering petroleum comprising:
providing an oil recovery formulation that comprises at least 75 mol % dimethyl sulfide and that is first contact miscible with liquid phase petroleum;
introducing the oil recovery formulation into a subterranean petroleum-bearing formation comprising petroleum having a dynamic viscosity of at least 1000 mPa s (1000 cP) at 25° C. and an API gravity of at most 20°;
contacting the oil recovery formulation with the petroleum in the subterranean formation; and
producing petroleum from the formation after introduction of the oil recovery formulation into the formation and contact of the oil recovery formulation with the petroleum.

2. The method of claim 1 wherein the subterranean formation is located at a depth of at least 75 meters below the surface of the earth.

3. The method of claim 2 wherein the subterranean formation is located at a depth of between 75 to 200 meters below the surface of the earth and the oil recovery formulation is introduced into the formation at a pressure of at most 8.2 MPa (1200 psi).

4. The method of claim 1 further comprising introducing steam into the subterranean formation.

5. The method of claim 4 wherein the steam is introduced into the formation together with the oil recovery formulation.

6. The method of claim 1 wherein the oil recovery formulation is introduced into the formation by injection via a first well extending into the formation.

7. The method of claim 6 wherein the petroleum is produced from the formation via the first well.

8. The method of claim 6 wherein the petroleum is produced from the formation via a second well extending into the formation.

9. The method of claim 8 wherein the second well is located below the first well in the formation.

10. The method of claim 1 wherein the oil recovery formulation in the liquid phase is first contact miscible with the petroleum in, or from, the formation.

11. The method of claim 1 wherein the oil recovery formulation is first contact miscible with petroleum that comprises at least 25 wt. % hydrocarbons having a boiling point of at least 538° C. as measured by ASTM Method D7169.

12. The method of claim 1 wherein the oil recovery formulation has a dynamic viscosity of at most 0.35 mPa s (0.35 cP) at 25° C.

13. The method of claim 1 wherein the oil recovery formulation has an aquatic toxicity of LC₅₀>200 mg/l at 96 hours.

14. The method of claim 1 wherein the oil recovery formulation is produced from the formation with petroleum.

15. The method of claim 1 wherein, prior to introducing the oil recovery formulation into the formation, a fluid flow path is established in the formation by injecting steam into the formation or by hydraulically fracturing the formation, and wherein the oil recovery formulation is introduced into the formation in the fluid flow path.

16. The method of claim 1 further comprising the step of introducing an oil immiscible formulation into the petroleum-bearing formation subsequent to the introduction of the oil recovery formulation into the formation.

17. A system, comprising:
an oil recovery formulation comprised of at least 75 mol % dimethyl sulfide that is first contact miscible with liquid phase petroleum;
a subterranean petroleum-bearing formation comprising petroleum having a viscosity of at least 1000 mPa s (1000 cP) at 25° C. and an API gravity of at most 20°;
a mechanism for introducing the oil recovery formulation into the subterranean petroleum-bearing formation; and
a mechanism for producing petroleum from the subterranean petroleum-bearing formation subsequent to the introduction of the oil recovery formulation into the formation.

18. The system of claim 17 wherein the subterranean petroleum-bearing formation is at a depth of at least 75 meters below the surface of the earth.

19. The system of claim 17 wherein the oil recovery formulation is first contact miscible with petroleum in, or from, the petroleum-bearing formation.

20. The system of claim 17, wherein the mechanism for introducing the oil recovery formulation into the subterranean petroleum-bearing formation is located at a first well extending into the subterranean formation.

21. The system of claim 20 wherein the mechanism for producing petroleum from the subterranean petroleum-bearing formation is located at the first well extending into the subterranean formation.

22. The system of claim 20 wherein the mechanism for producing petroleum from the subterranean petroleum-bearing formation is located at a second well extending into the subterranean formation.

23. The system of claim 22 wherein the second well is located beneath the first well in the formation.

24. The system of claim 17 further comprising a boiler for producing steam and a mechanism for introducing the steam into the subterranean formation.

25. The system of claim 17 further comprising a mechanism for hydraulically fracturing the subterranean formation.

26. The system of claim 17 further comprising:
an oil immiscible formulation; and
a mechanism for introducing the oil immiscible formulation into the petroleum-bearing formation.
